(19) United States
(12) Patent Application Publication
(10) Pub. No.: US 2005/0080750 A1
(43) Pub. Date: Apr. 14, 2005

(54) Integrated job accounting in a printing press environment

(75) Inventors: Richard R. T. Carling, Webster, NY (US); David W. Dellert, Fairport, NY (US)

Correspondence Address: Lawrence P. Kessler;Patent Legal Staff, Eastman Kodak Company, 343 State Street, Rochester, NY, 14650-2201, US

(73) Assignee: Eastman Kodak Company

(21) Appl. No.: 10/961,721

(22) Filed: Oct. 8, 2004

Related U.S. Application Data
(60) Provisional application No. 60/510,917, filed on Oct. 14, 2003.

(51) Int. Cl. G06F 17/60

(52) U.S. Cl. 705/400

(57) ABSTRACT

Automatically determining the cost to complete a printed job on a digital printing press. A Job Control Component in the Digital Front End of the printing press collects and stores the processing information from the job processing components after each has completed its step in the sequence of steps required to complete the printed job. A Job Reporting Component displays the stored processing information and, when the press owner has stored the predetermined cost of each processing step, automatically computes and displays the cost of the job.

### FIELD OF THE INVENTION

This invention relates to job accounting of computer controlled job mode processes for printing presses for example, and more particularly, to determining the cost to complete a job in such processes.

### BACKGROUND OF THE INVENTION

A job mode process is one that carries out and completes jobs or tasks in a sequence determined by a job-input schedule. In some job mode processes all jobs are alike, requiring the same steps and effort to complete. In these processes the cost per job, once determined, can be assumed to be the same for all jobs. However, in other job mode processes, jobs may be variable, requiring variable steps and effort to complete. In these processes the cost per job will therefore also be variable. A method to automatically determine the cost to complete a job in such a system is desirable so as to enable an accurate and efficient billing system.

Modern digital printing presses are exemplary of such job mode processes in which jobs, and therefore job cost, are highly variable. Job workflow in the printing industry has changed significantly with the advent of desktop computers and desktop publishing software applications. Automated and digital prepress techniques have replaced manual and analog ones. Today the print job customer can perform most of the prepress tasks that in the past were performed by several different people or groups, i.e., designer, photo scanner, photo retoucher, illustrator, layout artist, and page imposer. The result is input to the printer in the form of an electronic file, either on some type of electronic media such as a CD, or directly via network such as the internet. Often these electronic job files are saved in a file format that cannot be directly used for printing on the digital press, and must therefore be transformed to a format that can be handled by the press.

Examples of modern digital printing presses are the Heidelberg Quickmaster DI, Speedmaster DI, and Digimaster 9110, and the NexPress 2100 Digital Production Color Press. In the Quickmaster DI and Speedmaster DI printing plates are created from the electronic job files, directly on the press, and then used to print large numbers of pages by the offset lithographic process. On the other hand, electrophotographic imaging technology is used in the Digimaster 9110 and NexPress 2100 Digital Production Color Press. Electrophotographic imaging enables every page of the job to contain different information. With the numerous modifications that can be made to a print job after it has been submitted, it is very important for the press owner to have a way to capture all of the changes to a job that can create additional cost to the owner, so that these costs can be passed on to the print job customer in an accurate and timely itemized bill.

### SUMMARY OF THE INVENTION

In view of the above, this invention is directed to automatically determining and computing the itemized cost of a print job upon completion of the job and displaying that itemized cost to the printing press owner. The method of the invention is programmed in the digital front-end of the printing press. A Job Control Component is responsible for stepping a job through the sequence of processing steps necessary to complete the job, including converting the job file, submitted electronically in a page description file format, into a raster pixel file to be sent to the press. Each of the steps in the sequence of steps required to complete the job is controlled by a corresponding job processing component. The Job Control Component provides each job processing component with a template for processing information that is carried out by the job processing component. After each job processing component finishes processing a step, the template of information is returned to the Job Control Component and stored in a database. After completion of the job, a Job Reporting Component can, upon request from the press owner, display, on a graphical user interface, a list of all the templates of information for the job. If the press owner programs into the Job Reporting Component the predetermined costs of each job processing step, the cost of the job can be automatically computed.

The invention, and its objects and advantages, will become more apparent in the detailed description of the preferred embodiment presented below.

### BRIEF DESCRIPTION OF THE DRAWINGS

The invention and its technical advantageous effects will be better appreciated from the ensuing detailed description of a preferred embodiment, reference being made to the accompanying drawings in which:

FIG. 1A is a schematic drawing of a digital printing press, in which the method of the present invention may be implemented;

FIG. 1B is a block diagram representation of the digital printing press in FIG. 1A;

FIG. 2 is a schematic diagram of the electrophotographic imaging hardware in the digital printing press in FIG. 1A; and

FIG. 3 is a block diagram representation of the method of the present invention as practiced in the digital printing press in FIG. 1A.

### DETAILED DESCRIPTION OF THE INVENTION

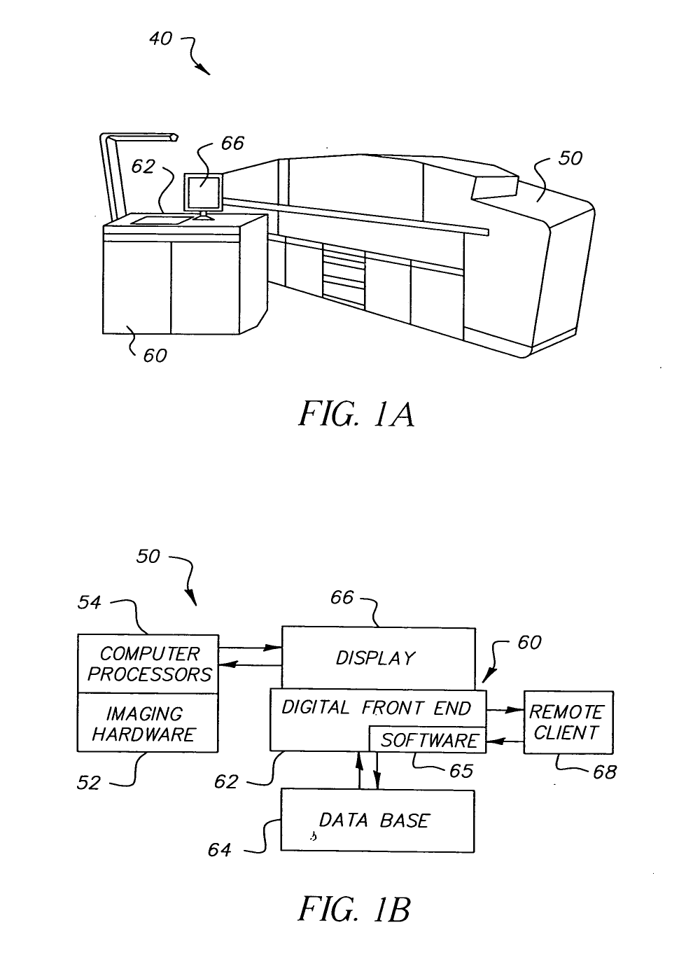

Referring to FIG. 1A, there is shown a schematic line drawing of a digital printing press 40, for example a NexPress 2100 Digital Production Color Press, in which the method of the present invention may be used. FIG. 1B depicts the same digital press in block diagram format. The digital press 40 in FIGS. 1A and 1B includes a print engine 50 and an operator interface 60. The print engine 50 contains the printing process components that convert a raster pixel input into hard copy printed output. The printing process components in the print engine 50 include the imaging hardware 52 and the computer processors 54 that control the imaging hardware. In the shown printing press 40, the imaging hardware 52 is electrophotographic printing technology that will be described below. The operator interface 60 contains the computational devices, henceforth referred to as the digital front end (DFE) 62, that perform all of the necessary pre-printing steps to convert the job file into the raster pixel format to be sent to the print engine 50. The operator interface 60 also contains data base storage media 64 and graphical user interface software 65 for interacting with the operator via graphical user interface display 66, or with the press owner via a remote client computer and display 68.

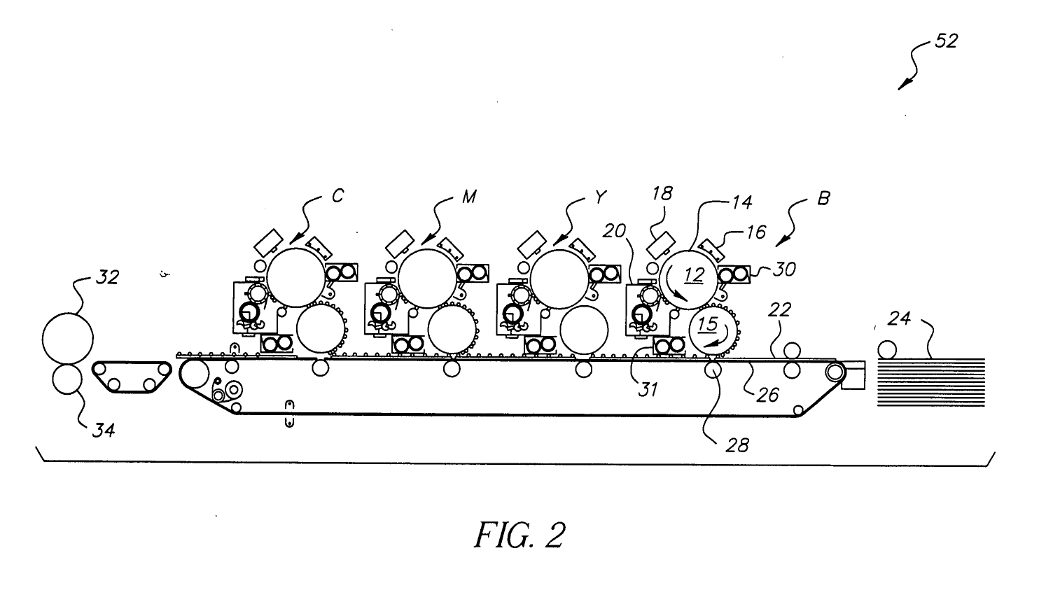

FIG. 2 depicts a schematic diagram of the electrophotographic imaging hardware 52 in print engine 50 of FIG. 1A. Four color images, black, yellow, magenta, and cyan are printed, by four printing modules, B, Y, M, C, onto the print media sheet 22. Of course, a different number of printing modules (greater or less than four) is suitable for use with this invention. The imaging elements and process are identical in the four printing modules. Therefore only the elements in printing module B are designated with numerals. The following description of the imaging process applies to all four modules B, Y, M, C. An imaging drum 12 is provided on which is coated a photoconductive member 14. The imaging drum 12 is selectively rotated, by any well-known drive mechanism (not shown), in the direction indicated by the arrow, to advance the photoconductive member 14 past a series of subsystems of the printing module. A primary charging device 16 is provided to deposit a uniform electrostatic charge onto the photoconductive member 14. The uniform charge on the photoconductive member 14 is subsequently selectively dissipated by a digitally addressed exposure subsystem 18, such as a Light Emitting Diode (LED) array, to form an electrostatic latent image of a document to be reproduced. The electrostatic latent image is then rendered visible by development subsystem 20, which deposits charged, pigmented marking particles onto the photoconductive member 14 in accordance with the electrostatic charge pattern of the latent image.

The developed marking particle image is then transferred from photoconductive member 14 to an intermediate transfer member 15. The electric field to transfer the marking particle image from photoconductive member 14 to intermediate transfer member 15 is provided by an appropriate bias voltage applied to intermediate transfer member 15. Meanwhile, cleaner 30 cleans away any marking particles that are not transferred from the photoconductive member 14 to the intermediate transfer member 15.

The marking particle image is transferred from intermediate transfer member 15 to print media sheet 22 that has been fed from supply 24 onto the transport belt 26. The electric field to transfer the marking particle image from the intermediate transfer member 15 to the print media sheet 22 is provided by electrically biased roller 28. Cleaner 31 is provided to clean any marking particles that are not transferred from intermediate transfer member 15 to the print media sheet 22. The print media sheet 22 bearing the marking particle image is then transported through printing modules Y, M, C to similarly form superimposed, registered, marking particle images on the media sheet 22 to create a full color image. Thereafter, the print media sheet 22 is transported into the nip formed between fuser roller 32 and pressure roller 34 wherein the composite marking particle image is fused by heat and pressure to the print media sheet 22.

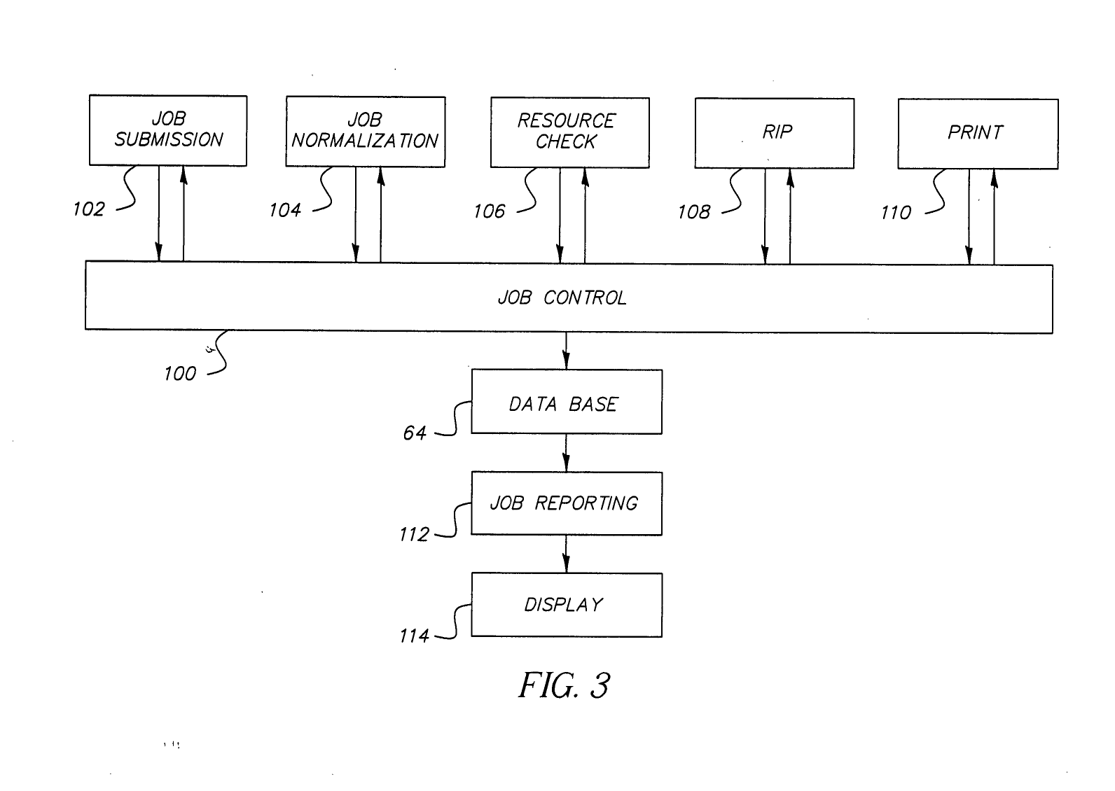

The method of this invention as embodied in the printing press 40 is illustrated schematically in block diagram form in FIG. 3. A Job Control Component 100 is responsible for stepping a job through the sequence of processing steps necessary to complete the job, including conversion of the job from the submitted page description format to the raster pixel format that is input to the print engine. In this embodiment this sequence of steps is Job Submission (102), Job Normalization (104), Resource Check (106), Raster Image Processing (RIP) (108), and Printing (110). Job Submission (102) includes recording the start time of the job, assigning a job name and job ID (Identification Code), and identifying the submitted job file format. Job Normalization (104) is the step in which the job file format from the Job Submission (102) step is converted from that format in which it was submitted into a special normalized PDF format required by the RIP. The Resource Check (106) step is a check to confirm that the print media (paper, type, size, weight, etc.) requested for the job is available in one of the supplies of the printing press 40, and that the type fonts requested are available. RIPing (108) is the step in which the job file format is converted to the raster pixel format required by the print engine. Printing is the actual creation of the hard copy prints in the print engine 50. These are the steps in the embodiment of this invention as implemented, for example in the NexPress 2100 Digital Production Color Press. It should be recognized by those skilled in the art that other printing presses or other types of job mode devices in which the method of this invention can be practiced may have different sequences of job processing steps.

In this embodiment each step in the job processing sequence is carried out by a corresponding job processing component (not shown) within the DFE 62. The Job Control Component 100 provides each job processing component with a template for processing information that may be carried out by the specific processing component. Chart #1 provides a mapping of job processing component to data collected for that component. After each job processing component finishes processing, the template of information for that processing component is returned to the Job Control Component 100 and stored in a database 64.

CHART 1

| Data Collected | Job Processing Component |
|---|---|
| Job Creation Time | Job Submission (Job Control on a reprint, |
| | copied or edited job) |
| Job ID | Job Submission (Job Control on a reprint, |
| | copied or edited job) |
| Job Name | Job Submission (Job Control on a reprint, |
| | copied or edited job) |
| Data Format_(PDF, PS, VDX) (Job Control on a | Job Submission (Job Control on a reprint, |
| reprint, copied or edited job) | copied or edited job) |
| Parent Job ID if it exists | Job Control |
| Submitted Job ID (Job Control) | Job Control |
| Job is a reprint of a done job | Job Control |
| Job is a Copy Job | Job Control |
| Job has been content edited | Job Control |
| Job Ticket has been edited | Job Control |
| Job has been deleted | Job Control |
| Number of Instance Documents (VDX) | Normalization Component |
| Media Name of Body Media needed | Resource Check component |
| Media Weight (in gsm) of Body Media needed | Resource Check component |
| Media Size (in mm) of Body Media needed | Resource Check component |
| Media name of Cover Media needed | Resource Check component |
| Media Weight (in gsm) of Cover Media needed | Resource Check component |
| Media Size (in mm) of Cover Media needed | Resource Check component |
| Media Name of Insert Media needed | Resource Check component |
| Media Weight (in gsm) of Insert Media needed | Resource Check component |
| Media Size (in mm) of Insert Media needed | Resource Check component |
| Color Spaces (sequence) | Resource Check component |
| Spot Colors (sequence) | Resource Check component |
| File Size of PDF | Normalization Component |
| Engine Path; One Sided or Two-Sided Path of | Resource Check |
| the Press | |
| Imposition Type (Plain, Parameterized and | Resource Check |
| Template) | |
| Number of Copies requested | Resource Check |
| Number of Sheets of Body Media per copy | Resource Check |
| Number of Sheets of Cover Media per copy | Resource Check |
| Number of Sheets of Insert Media per copy | Resource Check |
| Actual number of Body Media Body sheets | Print Component |
| printed | |
| Actual number of Cover Media sheets printed | Print Component |
| Actual number of Insert Media sheets printed | Print Component |
| Number of Body Media Sample sheets printed | Print Component |
| Actual number of Cover Media Sample sheets | Print Component |
| printed | |
| Actual number of Insert Media Sample sheets | Print Component |
| printed | |
| Number of Conditioning sheets printed | Print Component |
| Media Name of Conditioning Sheets | Print Component |
| Start Time - End Time - Processing Time | All components |
| Elapsed Time of Job - Start Time from Creation | Derived |
| to End Time of last Processing step performed | |
| on this job | |
| Process Time (total time of all processing steps | Derived |
| of this Job) | |
| A4 Page counters of the Press at the end of | Print Component |
| printing - Required for calculating Waste in the | |
| Job Summary (aggregate level) | |
| % Ink coverage for 4 (or 5) inks used, a number | RIP Component |
| between 0 and 100 as a floating point number | |
| (for precision) | |
| Grams of Dry Ink used estimate 4 (or 5) inks as | RIP Component/Print Component |
| a floating point number | |
| Finishing Style (Perfect Bound, Saddle Stitch, | Print Component |
| Cut and Pile etc. see Job Ticket Editor) | |
| Collation State (On-Off) | Print Component |
| Jog Setting (On - Off) | Print Component |
| Output Destination (Main Delivery, Proof Tray) | Print Component |
| Page Order (face up, face down) | Print Component |
| JTE Sidedness (One Sided, Two Sided H2H, | Print Component |
| Two Sided H2F) | |

It is possible that, before job completion, job processing may be re-routed through some or all of the job processing sequence steps. Some of the various reasons why that might happen are the following: Typically one set of job prints is printed as a proof to confirm that the output meets the customer's approval. If the proof does not meet customer approval, the job will be edited and re-routed through the job processing sequence to produce another proof. Several proofs may be printed before the customer approves. Even if print quality attributes meet customer approval, the customer, upon seeing the prints for the first time, may request other types of job editing such as content or imposition changes, or different print media. The customer may also decide that he/she wants more copies than originally requested.

If the job is edited or modified or reprinted, the Job Control Component 100 must move the job back to the specific processing step required for the change that was made. If an operator requests that the job be reprinted, the Job Control Component 100 will route the job back through the RIP processing (108) and Print processing (110) components. If a Job is edited for changes in color correction or number of copies, the job will also be routed to RIP and to Printing. Usually in both of these cases, the RIP processing just verifies that the raster data is resident in a Page Buffer memory, but it is possible that the pages are no longer in the Page Buffer memory and the job must be re-ripped. If the job is content edited, or the imposition of the job modified, the Job Control Component 100 must insure that the RIP process flushes the old raster pages for this job and re RIPs the job with the new content or imposition changes. If the media types in the job change, then the job must be run through the Resource Check component (106).

To capture the processing information from each job processing component and store it persistently, a Job Statistics Object (JSO) is created in the Job Control Component 100. The templates of job processing information from each job processing step are stored in the JSO. In the original Job Submission step 102, the job is assigned an identifier (ID) that is designated the Submitted Job ID. Each time a job is re-routed back in the sequence of job processing steps, a sub-job ID is assigned and a new JSO for that sub-job ID is created; this allows the system to capture the processing information each time a processing step is performed. In effect a family of jobs may be created for an originally submitted job.

A Job Reporting Component 112 is responsible for creating various job accounting reports from the job processing information accumulated and stored by the Job Control Component 100. The Job Reporting Component 112 can provide the press owner with a detailed account of what processing was performed on the press over a window of time, typically a press shift, or it can provide a Job Family Report for billing purposes. To provide a Job Family Report the Job Reporting Component takes a given job ID and queries the database 64 for the specific JSO with a matching Job ID field. The Submitted Job ID field of this specific JSO is then retrieved. The Submitted Job ID is then used to perform a second query for all jobs that have the same Submitted Job ID. The records returned from this query provide the Job Reporting Component 112 with all jobs that originated for the specific initial submitted job. This provides the needed mechanism for tracking copies of jobs, either specifically copied by the operator or saved with a different name after an Edit. Also, this picks up jobs that underwent the same processing steps multiple times, such as reprints, proof jobs, color tweaks, etc. If the press owner chooses to enter into the Job Reporting Component his/her predetermined costs for each step in the job sequence, the cost of the complete job can be automatically computed and included in the Job Family Report which is sent to a display 114, for example to the graphical user interface display 66 or remote client 68 display.

The invention has been described in detail with particular reference to certain preferred embodiments thereof, but it will be understood that variations and modifications can be effected within the spirit and scope of the invention.

1. A method of automatically determining the cost to produce a complete job on a device, said method comprising:
for said device, defining a plurality of sequential steps in a job processing sequence required to produce said job, each sequential step in said job processing sequence being carried out by a corresponding job processing component;
storing a template of processing information from each said job processing component after said job processing component completes its said sequential step in said job processing sequence; and
using a predetermined cost to carry out each said step in said job processing sequence, and said stored templates of processing information from said job processing components, computing the total cost of completing said job processing sequence.

2. The method of claim 1, further including the step of displaying a list of all said templates of processing information for said job processing sequence and said computed total cost of completing said job processing sequence.

3. The method defined in claim 1, wherein said job processing sequence includes steps to convert a job file, submitted electronically in a page description language, into a raster pixel file format to be sent to said printer.

4. A method of automatically determining the cost to produce a complete printed job on a printing press, comprising:
for said printing press, defining a plurality of sequential steps in a job processing sequence required to produce said printed job, each said sequential step in said job processing sequence being carried out by a corresponding job processing component;
storing a template of processing information from each said job processing component after said job processing component completes its said sequential step in said job processing sequence; and
using a predetermined cost to carry out each said step in said job processing sequence and said stored templates of processing information from said job processing components, computing the total cost of completing said job processing sequence.

5. The method of claim 4, further including the step of displaying a list of all said templates of processing information for said job processing sequence and said computed total coast of completing said job processing sequence.

6. The method defined in claim 4, wherein said job processing sequence includes steps, in said printing press, to convert said raster pixel file into a hard copy printed output.

7. The method defined in claim 6, wherein said job processing sequence includes repetition of at least one of said steps in said job processing sequence to modify said job processing sequence.

8. The method defined in claim 6, wherein said job processing sequence includes repetition of at least two sequential said steps in said job processing sequence to modify said job processing sequence.

9. The method defined in claim 6, wherein said job processing sequence includes a plurality of repetitions of at least one of said steps in said job processing sequence to modify said job processing sequence.

10. The method defined in claim 6, wherein said job processing sequence includes a plurality of repetitions of at least two sequential said steps in said job processing sequence to modify said job processing sequence.

11. A system for automatically determining the cost to complete a job comprising:
computer processor for controlling a plurality of job processing components, each said job processing component being responsible for carrying out one of a plurality of steps in a job processing sequence;
means for storing a template of processing information from each said job processing component, after said job processing component completes its corresponding step in said job processing sequence; and
means for automatically computing and displaying the cost for completing said job based on the list of all said templates of processing information stored for said job processing sequence and a predetermined cost for each said step in said job processing sequence of steps.

12. System of claim 11, further including a display device for displaying a list of all said templates of processing information stored for said job processing sequence and said computed cost of completing said job processing sequence.

13. A system for automatically determining the cost to produce a complete printed job comprising:
computer processor for controlling a plurality of job processing components, each said job processing component being responsible for carrying out one of a plurality of steps in a job processing sequence necessary to complete said printed job;
means for storing a template of processing information from each said job processing component, after said job processing component completes its step in said job processing sequence; and
means for automatically computing and displaying the cost for completing said printed job based on the list of all said templates of processing information stored for said job processing sequence and a predetermined cost for each said step in said job processing sequence of steps.

14. System of claim 13, further including a display device for displaying a list of all said templates of processing information stored for said job processing sequence and said computed cost of completing said job processing sequence.

15. The system defined in claim 13, wherein said computer controlled job processing sequence includes a plurality of steps required to convert said printed job, submitted electronically in a page description language, into a raster pixel file format to be sent to a printing press.

16. The system defined in claim 15, wherein said computer controlled job processing sequence includes steps, in said printing press, to convert said raster pixel file into a hard copy printed output.

17. The system defined in claim 16, wherein said computer controlled job processing sequence includes at least one repetition of at least one of said steps in said job processing sequence.

18. The system defined in claim 16, wherein said computer controlled job processing sequence includes at least one repetition of at least two sequential said steps in said job processing sequence.
